(19) United States
(12) Patent Application Publication
(10) Pub. No.: US 2006/0166582 A1
(43) Pub. Date: Jul. 27, 2006

(54) Composite higher temperature needlefelts with woven fiberglass scrims

(76) Inventor: Abraham Kweku Turkson, Woodridge, NY (US)

Correspondence Address: TECHNICAL FELTS COMPANY, 43 EDELWEISS DRIVE, WOODRIDGE, NY, 12789, US

(21) Appl. No.: 11/041,143

(22) Filed: Jan. 24, 2005

(51) Int. Cl. B32B 5/06

(52) U.S. Cl. 442/270; 442/271; 442/272

(57) ABSTRACT

Composite higher temperature needlefelts manufactured by needle punching webs of staple fibers into a layer of woven fiberglass scrim to generate structural integrity superior to needlefelts of the staple fibers of equivalent weight and less particulate emission than woven fiberglass fabric of equivalent weight when used for filtration applications.

### FIELD OF THE INVENTION

This invention relates to needlefelts. It specifically relates to needlefelt materials involving combination of higher temperature staple fibers with woven fiberglass scrims.

### BACKGROUND OF THE INVENTION

Woven fiberglass fabrics of varied physical characteristics are employed in many applications including reinforcement in engineered structures, thermal and acoustic insulation, substrates for composite materials, particulate removal in baghouse unit operations, and protection from weld splatter.

However, emission rates are generally higher than desirable levels when woven fiberglass fabrics are used to remove particles predominantly less than one-micron particle size. This is caused by sub micron particles penetrating the relatively large pore sizes generated in woven fabric structures in general by overlapping yarns. To rectify this deficiency, polytetrafluoroethylene (PTFE) membranes have been laminated to woven fiberglass substrates to reduce the pore size and reduce emission levels. However, not only is the price of the resultant structure substantially higher than the replacement substrate but the membranes are relatively fragile and are damaged by abrasive particles such as those found in foundries, power plant and other applications where extremely low emissions are desirable.

Attention is directed to U.S. Pat. No. 5,130,134 entitled “Polyimide composite filter fabrics” which provided an alternative method for achieving relatively low emission levels while overcoming the susceptibility of membranes to premature destruction by abrasive particles. However, the Achilles' heel of this method is the stipulation to employ chemically susceptible P84 polyimide fibers in the filtration (upper) layer. Polyimide composite filter fabrics are also significantly more expensive than the substrates they are designed to replace, thereby severely limiting their commercialization.

In the field of splatter protection, U.S. Pat. No. 6,696,374 describes a “needle punched webbing of pre-oxidized, polyacrylonitrile fibers” that protects equipment from molten metal spatter near welding locations. This fabric has found increasing favor at the expense of woven fiberglass fabrics in spatter protection applications due to superior insidious thermal protection. However, this construction suffers from relative fragility due to extremely low tensile strength characteristics.

U.S. Pat. No. 4,743,495 describes a seat cushion fire blocking fabric comprised of at least two felted plies stabilized by a woven fiberglass scrim. The fibers in the plies were selected from aramid, polybenzimidazole and phenolic fibers. The preferred fabric weight was 9.3 oz/sq. yd., including a preferred scrim weight of 1.6 oz/sq. yd.

U.S. Pat. Nos. 5,474,838 and 5,569,430 describe roofing membranes, including reinforcement material consisting of a fiberglass scrim fabric to which was stitched or knitted a layer of nonwoven thermoplastic staple fibers formed from polyester and/or nylon. The nonwoven material was stitched or knitted to the fiberglass scrim on a Malimo or weft insertion machine with stitch through capability.

U.S. Pat. No. 5,470,648 describes composite fabrics of nonwoven nylon layers and fiberglass scrim. The composite fabrics, useful as backings in a carpet assembly, were joined preferably through hydro-entanglement or needle punching. The fiberglass was said to be effective because of its good tensile strength and thermal dimensional stability, which allowed weak shrinkage forces in the unbonded nylon fabric to be negated.

Attention is next drawn to U.S. patent application Ser. No. 20040117958 in which high temperature needle-felts with woven basalt scrims were described. However, the fact that basalt substrates are not traditionally widely used for industrial filtration may limit utilization of basalt-based fabrics for baghouse applications.

It is therefore an object of this invention to provide higher temperature textile materials for removing particulate matter from gas streams, providing improved filtration efficiency compared with woven fiberglass fabric of equivalent weight.

It is a further object of this invention to provide higher temperature textile materials for removing particulate matter from gas streams that are more economical than filter materials constructed from webs of higher temperature staple fibers.

It is another object of this invention to provide textile materials with improved mechanical properties compared to materials constructed from webs of higher temperature staple fibers.

### SUMMARY OF THE INVENTION

This invention provides composite materials comprising a nonwoven first layer comprising higher temperature staple fibers. Preferably, the staple fibers are selected from those having continuous thermal stability greater than 300 degrees Fahrenheit, examples of which are polyphenylene sulfide (Procon™ and Torcon™), meta-aramid (Nomex™ and Conex™), para-aramid (Kevlar™ and Twaron™), polyimide (P84™) preoxidized polyacrylonitrile (PAN) and fully oxidized carbon, polytetrafluoroethylene (PTFE) and mixtures thereof. The second layer is a woven fiberglass scrim being comprised either of spun or continuous multifilament yarns. A third layer comprising nonwoven higher temperature staple fibers of the type described for the first layer may or may not be added. Suitably, the layers are overlapped and then mechanically bonded together by needle punching to prevent delamination and stretching.

The basis for the present invention, descriptions and advantages stated above will be explained in further detail by the drawings and preferred embodiments provided below.

### IN THE DRAWINGS

FIG. 1 shows an embodiment of the present invention by which a web of one type of higher temperature staple fibers has been combined with a woven fiberglass fabric substrate by needle punching to produce a composite structure comprising of two discrete layers.

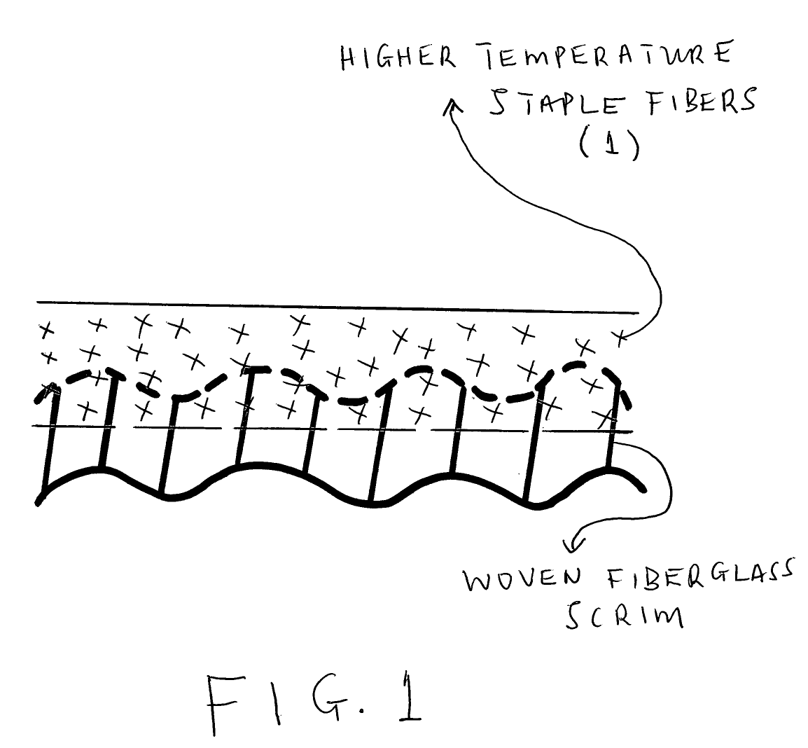

FIG. 2 shows an embodiment of the present invention in which different types of higher temperature staple fibers have been mixed to produce a web, which has then been combined with a woven fiberglass substrate by needle punching to produce a composite structure comprising of two discrete layers.

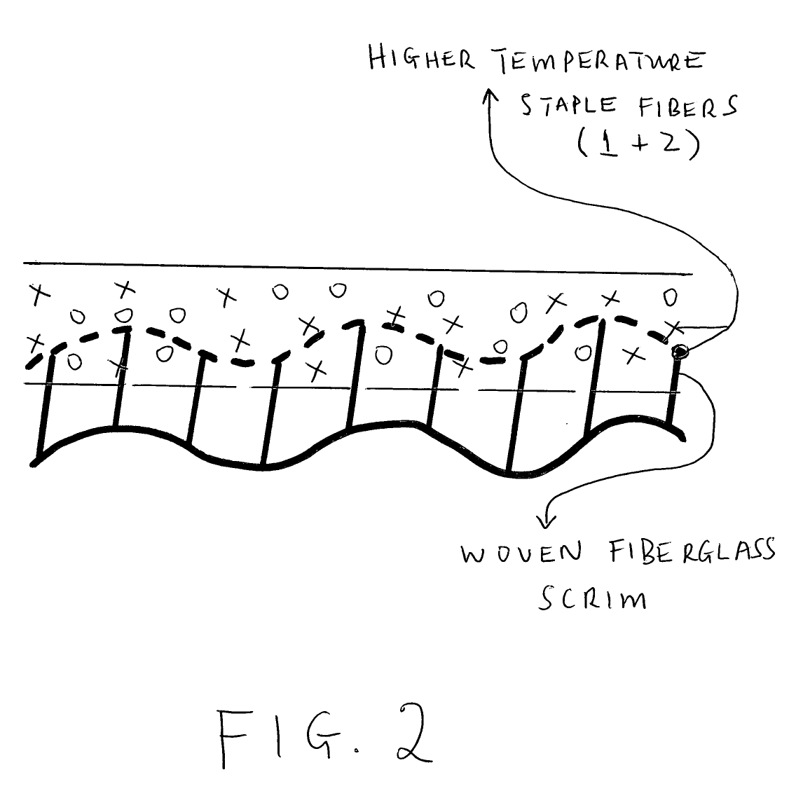

FIG. 3 shows an embodiment of the present invention in which a woven fiberglass fabric has been sandwiched between two webs comprised of higher temperature staple fibers by needle punching.

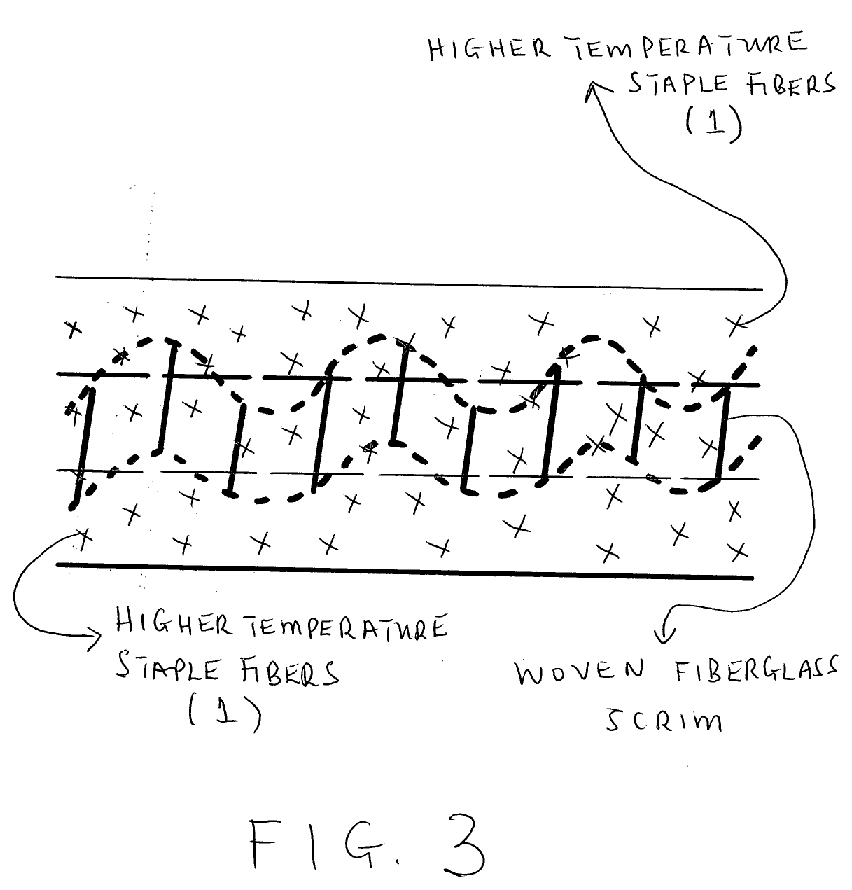

FIG. 4 shows an embodiment of the present invention in which a woven fiberglass fabric has been sandwiched between an upper web comprised of one type of higher temperature staple fibers and a lower web comprised of a different type of higher temperature staple fibers by needle punching.

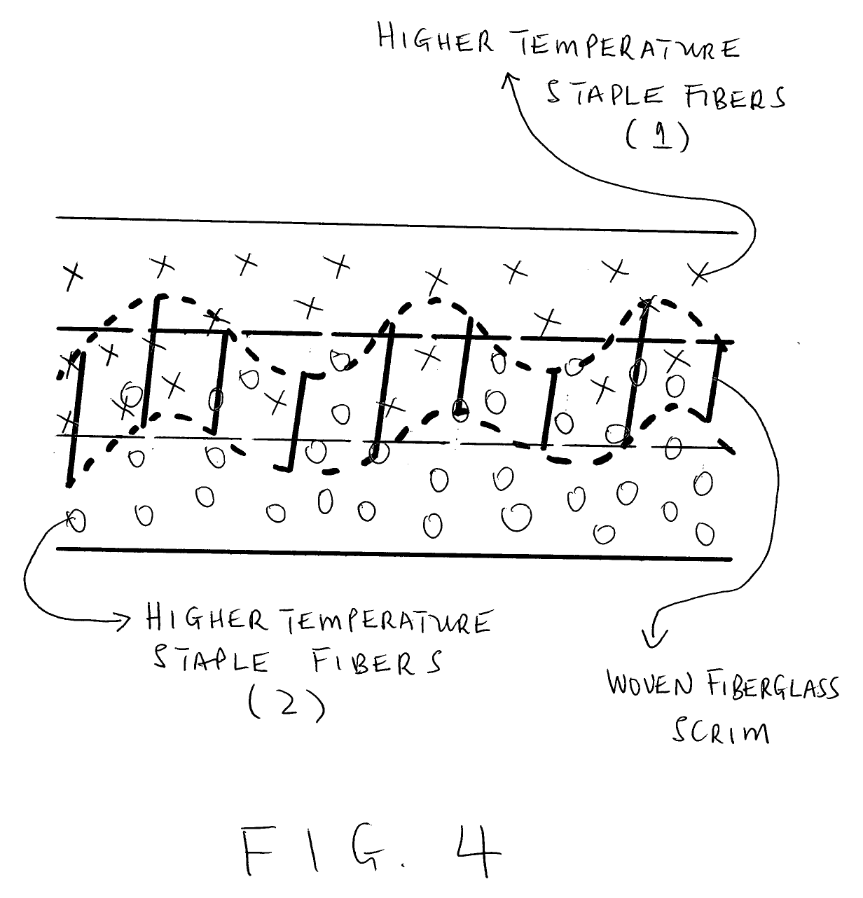

FIG. 5 shows an embodiment of the present invention in which a woven fiberglass fabric has been sandwiched between an upper web comprised of a blend of different higher temperature staple fibers and a lower web comprised of one type of higher temperature staple fibers by needle punching.

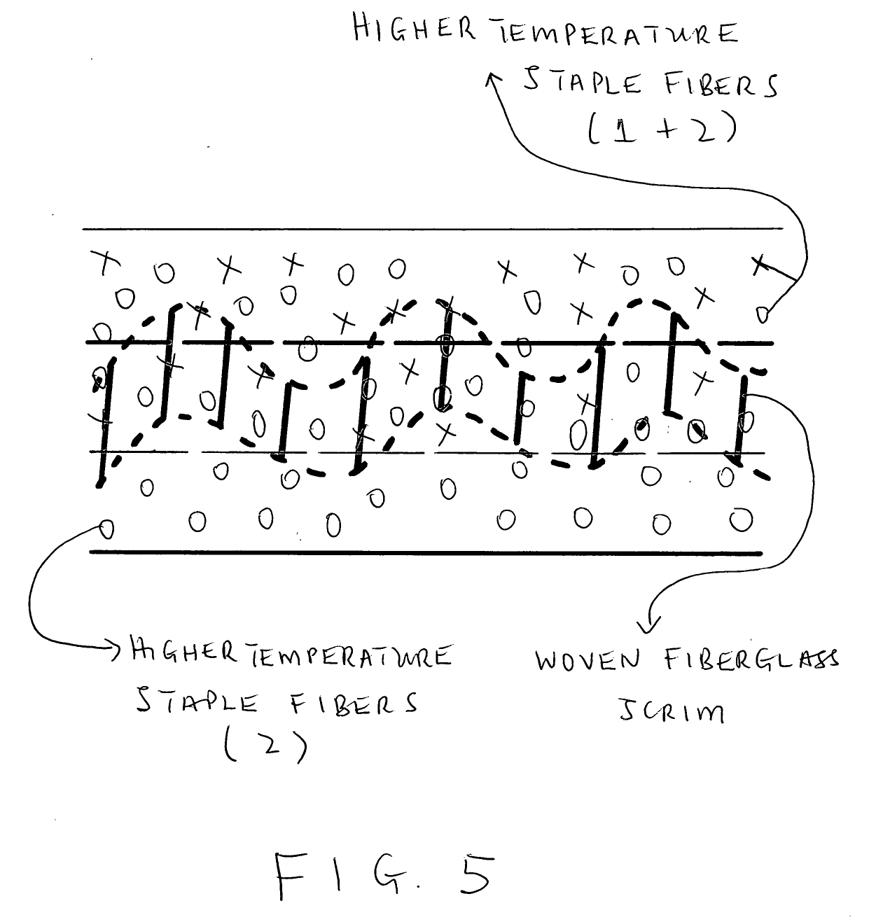

### DETAILED DESCRIPTION OF THE INVENTION

Needle punching is a unit operation in which several barbed needles at close proximity penetrate layers (or batts) of fibers, with or without an interlocking scrim, at high speed. As the needles move up and down, the barbs at the end of the needles capture fibers from lower layers and commingle them with fibers in upper layers, thereby strengthening the bond between fibers in different layers. The resultant fabric is a three-dimensional structure composed of fibers oriented in the X, Y, and Z directions, with Z-directional fibers causing several batts to be bonded tightly together. The structural integrity of the resultant fabric can be several orders of magnitude greater than that of single carded batts. Needle punching is an especially useful unit operation when batts of fibers are to be bonded to a woven substrate or when it is desirable to employ a scrim to further improve the structural integrity of batts of fibers. The bond created by needle punching action is generally stronger than that created by other unit operations such as chemical, thermal and hydro entanglement. This is especially true when the fibers to be bonded are thermoset fibers that cannot be plasticized.

This invention relates to bonding of mostly thermoset fibers to woven fiberglass fabrics. The end uses to which the inventions are to be employed require the useful integrity of the bond to be maintained for tensile loads up to, but not limited to, 1000 psi and temperatures up to, but not limited to, 600 degrees Fahrenheit.

To satisfy the physical prerequisites noted above, needle punching is the unit operation employed to integrate batts of mostly higher temperature thermoset fibers to a common denominating fiberglass scrim or substrate.

A preferred embodiment of this invention therefore relates to a method for integrating higher temperature fibers to woven fiberglass fabrics by needle punching to produce felts with structural integrity superior to felts constructed from webs of the corresponding higher temperature fibers of equivalent weight. Specifically, the Z-direction orientation of the fibers driven into the woven fiberglass fabric results in the formation of a strong bond between the structures that is not easily broken during applications for which the invention is intended.

In addition, this invention further relates to a method for integrating higher temperature fibers to woven fiberglass fabrics by needle punching to produce felts with superior filtration efficiency than the woven fiberglass fabric of equivalent weight. Specifically, intrusion of a web of staple fibers into woven fiberglass substrate results in considerable reduction in the pore size or opening of the woven fiberglass, resulting in a quantum leap in the ability of the composite structure to remove particles from dust laden gases.

In a further disclosure of this invention, the fibers selected for bonding by needle punching to woven fiberglass fabrics are those that suffer no more than 5% deterioration in tensile strength upon continuous exposure to temperatures of about 300 degrees Fahrenheit for a period of about 100 hours. Fibers satisfying this requirement are termed here as higher temperature fibers, examples of which include, but are not limited to, Nomex™, P84™, Procon™, PTFE, preoxidized PAN, fully oxidized carbon, Kevlar™, and mixtures thereof. These fibers fall into a category generally known as thermoset fibers and are characterized by charring as opposed to melting upon exposure to flames.

It is pertinent to surmise therefore that fibers that suffer more than 5% deterioration in tensile strength upon continuous exposure for about 100 hours at about 300 degrees Fahrenheit are excluded from the preferred embodiment. These fibers, termed here as lower temperature fibers, are generally of a thermoplastic nature in that melting occurs when exposed to flames. The principal cause for excluding these lower temperature fibers from the preferred embodiment is discovery during the inventing process that equivalent increase in structural integrity is achievable more economically by including as scrims woven structures other than fiberglass that are comprised of the same chemical structure as the staple fibers. Examples of fibers excluded from the preferred embodiment include but are not limited to polyester, polypropylene and nylon.

It is understood by those with knowledge of the state of the art that other embodiments of this invention are feasible and therefore desirable depending on the end use. For example, batts of fibers may be needle punched not only on one side of a woven fiberglass fabric but to both sides. When batts of fibers are needle punched to both sides of a woven fiberglass fabric, the resulting composite structure is such that the woven fiberglass is sandwiched between an upper layer batt and a lower layer batt. Depending on the particulars of the machinery, needle-punching batts to both sides of a woven fiberglass fabric may be accomplished in a single step or multiple steps.

It is further understood by those versed in the state of the art that another embodiment of this invention is the needle punching of batts of different fibers to each side of a woven fiberglass fabric. For example, a blend of P84™ polyimide fibers and Torcon™ may be needlepunched to the upper portion of the woven fiberglass fabric, while only Torcon™ batt is needlepunched to the lower portion of the woven fiberglass fabric. In this particular embodiment, the P84™ is responsible for generating even much lower emissions, while blending Torcon™ in the upper layer may minimize acid degradation or hydrolysis, two phenomena to which P84™ is particularly vulnerable. However, including the more expensive P84™ in the lower batt is redundant since that section generally carries less responsibility for particulate removal. Other permutations and combinations of fiber batts are envisioned based on the properties of the flue gas to which the composite structure is to be subjected.

Consistent with the present invention, only woven fiberglass fabrics of plain, satin or twill construction and comprised of spun or continuous multifilament yarns are specified for use as substrates or scrims.

It will be apparent still to those well versed in the state of the art that the construction of the woven fiberglass fabric used for this invention is dependent on the end use. As a substrate for improvement in filtration efficiency, the pore size of the woven fiberglass fabric is relatively small, requiring a tightly plain-woven construction comprised of either spun or continuous filament yarns. A satin or twill woven structure of a more open nature comprised of continuous multifilament yarns may be the preferred option when improvement in structural integrity is the principal objective.

However, while the woven fiberglass fabric may be of any weight based on the end use, the desired weight range is a minimum of 2.0 oz/sq.yd and a maximum of 20 oz/sq.yd. including any increments in between. The structural integrity of woven fiberglass fabrics weighing less than 2.0 oz/sq.yd. is generally not high enough to generate significant increase in the composite structure. Similarly, additional improvements in physical properties achieved with woven fiberglass fabrics weighing more than 20.0 oz/sq.yd are generally redundant for the intended end uses of this invention.

Similarly, while the composite structure comprising of needled batts of higher temperature staple fibers into woven fiberglass fabric may be of any weight, the desired weight range is a minimum of 10 oz/sq.yd. and a maximum of 30 oz/sq.yd. including any increments in between. Generally, the permeability of said composite materials weighing less than 10 oz/sq.yd is too high to sustain a high degree of filtration efficiency. Furthermore, the structural integrity of said composite materials weighing less than 10 oz/sq.yd. may not be sufficient to sustain an economically acceptable service life. On the contrary, said composite materials weighing more than 30 oz/sq.yd. may impose unbearable stress on support structures in filtration unit operations. Furthermore, the utility of said composite materials weighing more than 30 oz/sq.yd. is marginal at best in the intended end uses of this invention.

The utility of the present invention is severely constrained if the composition of the higher temperature fibers is marginal or excessive in relation to the woven fiberglass fabric. By this it has been found that optimal composition levels of higher temperature fibers are generally those between and including 10-90% by weight of the total weight of the composite structure. The present invention therefore envisions the composition of the higher temperature fibers in the composite structure to be between and including 10-90% by weight.

In a preferred embodiment consistent with the present invention, a batt of meta-aramid fibers such as Nomex™ fibers is needle punched into a woven fiberglass fabric to create a composite structure capable of withstanding continuous temperatures up to and including 400 degrees Fahrenheit. Dependent on the type of woven fiberglass fabric selected and composition ratios of Nomex™ to woven fiberglass, such a composite material is capable of withstanding short term (up to about 15 minutes) thermal exposures up to 500 degrees Fahrenheit. Nomex™ needlefelts regardless of weight are generally able to withstand short term (up to 15 minutes) thermal exposures up to about 450 degrees Fahrenheit.

In another preferred exemplary embodiment consistent with the present invention, a batt of para-aramid fibers such as Kevlar™ fibers is needle punched into a woven fiberglass fabric to create a composite structure capable of withstanding continuous temperatures up to and including 450 degrees Fahrenheit. Dependent on the type of woven fiberglass fabric selected and composition ratios of Kevlar™ to woven fiberglass, such a composite material is capable of withstanding short term (up to about 15 minutes) thermal exposures up to 550 degrees Fahrenheit. Kevlar™ needlefelts regardless of weight are generally able to withstand short term (up to 15 minutes) thermal exposures up to about 500 degrees Fahrenheit.

In another preferred exemplary embodiment consistent with the present invention, a batt of polyimide fibers such as P84™ is needle punched into a woven fiberglass fabric to create a composite structure capable of withstanding continuous temperatures up to and including 500 degrees Fahrenheit. Dependent on the type of woven fiberglass fabric selected and composition ratios of P84™ to woven fiberglass, such a composite material is capable of withstanding short term (up to about 15 minutes) thermal exposures up to 600 degrees Fahrenheit. P84™ needlefelts regardless of weight are generally able to withstand short term (up to 15 minutes) thermal exposures up to about 550 degrees Fahrenheit.

In another preferred exemplary embodiment consistent with the present invention, a batt of PTFE fibers such as Teflon™ is needle punched into a woven fiberglass fabric to create a composite structure capable of withstanding continuous temperatures up to and including 500 degrees Fahrenheit. Dependent on the type of woven fiberglass fabric selected and composition ratios of Teflon™ to woven fiberglass, such a composite material is capable of withstanding short term (up to about 15 minutes) thermal exposures up to 600 degrees Fahrenheit. Teflon™ needlefelts regardless of weight are generally able to withstand short term (up to 15 minutes) thermal exposures up to about 550 degrees Fahrenheit.

In another preferred exemplary embodiment consistent with the present invention, a batt of preoxidized PAN fibers is needle punched into a woven fiberglass fabric to create a composite structure capable of withstanding temperatures up to and including 2000 degrees Fahrenheit for periods up to 120 minutes. Depending on the composition ratios of preoxidized PAN fibers to woven fiberglass fabric, the tensile strength of the composite structure can be a factor of 100 greater than that of the preoxidized PAN.

In other preferred exemplary embodiments consistent with the present invention, batts needled to the upper and lower faces of woven fiberglass fabric are comprised of dissimilar higher temperature fibers. The batts in the upper and lower faces of woven fiberglass fabrics may be comprised of blends of higher temperature fibers depending on the end use.

The utility of the present invention is demonstrated by a simultaneous measurement of particulate penetrations generated by an example of the present invention, woven fiberglass of equivalent weight and a needlefelt comprised of only of higher temperature staple fibers. Nomex™ fibers with 2.2 dtex equivalent diameter and weighing 7.3 oz/sq.yd. were needlepunched to a woven fiberglass substrate weighing 12.7 oz/sq.yd. to create a composite material weighing 20.0 oz/sq.yd. A woven fiberglass fabric weighing 20 oz/sq.yd regularly used for Industrial filtration and a 14.0 oz/sq.yd. Nomex™ felt regularly used for industrial filtration applications were selected for a comparative test with the composite material. The permeabilities of the composite structure, woven fiberglass fabric and 14.0 Nomex™ felt were approximately the same at about 30 cfm at a pressure drop of 0.5 inch of water. 16 square-inch samples of all three media were bolted separately in three challenge chambers. A recirculated fluidized bed boiler dust with 0.5 micron average particle size was fed from a common duct and divided into each chamber at a dust loading of 50 grains/ft³ and a velocity of 8 ft/min. The amount of dust penetrating each fabric was collected at 15-minute intervals. The experiment was conducted over a period of 120 minutes. The concentration of particles penetrating the woven fiberglass fabric was 6.8, 3.2, 1.9, 1.2, 0.8, 0.5, 0.5, 0.5 and 0.5 grains/ft³. Results for the composite Nomex™/Fiberglass composite fabric were 2.9, 1.25, 0.60, 0.15, 0.08, 0.03, 0.03, 0.03 and 0.03 grains/ft³. Results for the 14.0 oz/sq.yd felt were 2.4, 1.15, 0.5, 0.12, 0.06, 0.03, 0.03, 0.03 and 0.03 grains/ft³. The results show that a composite needlefelt comprised of 36.5% Nomex™ fibers integrated into woven fiberglass fabric yielded emission values essentially the same as a 14.0 oz/sq.yd Nomex felt. Of particular relevance is the fact the typical raw material cost for the 14.0 oz/sq.yd is about 50% higher than that for the Nomex™/Fiberglass composite fabric. The results further showed that the emission generated by the composite Nomex™/Fiberglass composite fabric stabilized at a level significantly lower than that for a woven fiberglass fabric of equivalent weight and permeability. To put these values In perspective, assuming that the volumetric flow rate in say a cement plant accompanying the feed data is 50,000 ft³/hr implies daily emission rates of 5 pounds and 85 pounds for the Nomex™/Fiberglass composite fabric and the woven fiberglass fabric, respectively.

Improvement in mechanical integrity of filtration felts translates into an increased ability to withstand applicable stresses and an increase in useful service life, reduction in unplanned shut down, increase in productivity and a rise in derived economic benefits. Determination of the Mullen burst and tensile strength for the 20 oz/sq.yd. Nomex™/Fiberglass composite fabric described above yielded values of 1200 psi and 400 pounds, respectively, compared with 450 psi and 120 pounds for a 20 oz/sq.yd. Nomex™ needlefelt. The Mullen burst and tensile strength for the 14.0 oz/sq.yd. Nomex™ fabric were 400 psi and 100 pounds, respectively.

In another embodiment of the present invention, a 7.3 oz/sq.yd. web of preoxidized PAN fibers was needle punched to a woven fiberglass substrate weighing 12.7 oz/sq.yd to create a Preoxidized PAN/Fiberglass composite fabric weighing 20.0 oz/sq.yd. A preoxidized PAN fabric weighing 20.0 oz/sq.yd was constructed. The Mullen burst and tensile strength of the two fabrics were measured. Samples of the two fabrics measuring 6×6 inches were bolted in two separate holders and subjected to a burst of flames from an oxyacetylene flare for five minutes from a distance of two feet to determine extent of penetration. The Mullen burst and tensile strength of the preoxidized PAN/Fiberglass composite fabric were 1000 psi and 350 pounds, respectively. Relative values for the preoxidized PAN fabric were 40 psi and 10 pounds. Flame penetration for the two fabrics was essentially negligible. In addition raw material cost for the preoxidized PAN fabric was 30% higher than that for the preoxidized PAN/Fiberglass composite fabric.

The efficacy of the present invention is clearly demonstrated by a range of materials with filtration efficiencies comparable to conventional higher temperature needlefelts, but is more economic on a unit basis and characterized by superior mechanical integrity, leading to additional derived economic benefits.

Additionally, the present invention effects considerable reduction in potentially harmful particulate emissions when used as replacement for conventional woven fiberglass fabrics in industrial filtration applications.

Furthermore, the present invention effects significant improvement in the mechanical integrity of preoxidized PAN felt without sacrificing flame propagation, leading to mobilization in several applications where the weak structural integrity of the preoxidized PAN is a liability. Additionally, the present invention is a more economic alternative to preoxidized PAN.

Above examples are illustrations of advantages derived from the art of needle punching higher temperature fibers to woven fiberglass fabrics to form a composite structure of discrete layers or composite structures in which the woven fiberglass fabric is sandwiched between two layers of higher temperature fibers. In the context of the state of the art, the Nomex™/Fiberglass and the preoxidized PAN/Fiberglass composite fabrics described above and provided as examples of the present invention are novel products.

It will be evident to those versed in the state of the art that the embodiments presented here are not limiting of the scope of the present invention. It is apparent that several embodiments may be added in conformance with the domain of the claims for the present invention.

What is claimed is:

1. A composite textile material comprising higher temperature staple fibers entangled with a woven fiberglass fabric.

2. A composite textile material according to claim 1 wherein the higher temperature staple fibers are entangled with the woven fiberglass fabric by a needle punching operation.

3. A composite textile material according to claim 1 wherein the higher temperature staple fibers are fibers that retain at least 95% of their tensile strength after exposure to 300 degrees Fahrenheit temperature for a period of 100 hours.

4. A composite textile material according to claim 3 wherein said higher temperature staple fibers are selected from the group consisting of meta-aramid, para-aramid, polyphenylene sulfide, polyimide, polytetrafluoroethylene and preoxidized polyacrylonitrile.

5. A composite textile material according to claim 1 wherein the woven fiberglass fabric weighs between 2.0 and 20.0 oz/sq.yd.

6. A composite textile material according to claim 1 wherein the higher temperature staple fibers comprise between 10 to 90% of the total weight of the composite structure.

7. A composite textile material according to claim 1 wherein the weight of the composite structure varies between 10.0 and 30.0 oz/sq.yd.

8. A composite textile material according to claim 7 employed for the removal of fine particulate matter from a gas stream comprising a first layer consisting of higher temperature staple fibers selected from the group consisting of meta-aramid, para-aramid, polyphenylene sulfide and polytetrafluoroethylene; discrete layer of woven fiberglass substrate secured to said first layer; said layers being entangled by needle punching.

9. A composite textile material according to claim 7 employed for the removal of fine particulate matter from a gas stream comprising a first layer consisting of mixtures of higher temperature fibers selected from the group consisting of meta-aramid, para-aramid, polyphenylene sulfide, polyimide and polytetrafluoroethylene; discrete layer of woven fiberglass substrate secured to said first layer; said layers being entangled by needle punching.

10. A composite textile material according to claim 7 employed for weld spatter protection comprising a first layer of preoxidized polyacrylonitrile; discrete layer of woven fiberglass substrate secured to said first layer; said layers being entangled by needle punching.

11. A composite textile material comprised of a woven fiberglass fabric sandwiched between two layers of higher temperature staple fibers consolidated by first needle punching top layer of higher temperature staple fibers into woven fiberglass fabric, then turning over said structure to expose other side of woven fiberglass fabric, followed by needle punching bottom layer of higher temperature staple fibers.

12. A composite textile material according to claim 11 wherein the woven fiberglass fabric weighs between 2.0 and 20.0 oz/sq.yd.

13. A composite textile material according to claim 11 wherein the higher temperature staple fibers comprise between 10 to 90% of the total weight of the composite structure.

14. A composite textile material according to claim 11 wherein the weight of the composite material varies between 10.0 and 30.0 oz/sq.yd.

15. A composite textile material according to claim 14 employed for the removal of fine particulate matter from a gas stream wherein top layer of higher temperature staple fibers is selected from the group consisting of meta-aramid, para-aramid, polyphenylene sulfide, and polytetrafluoroethylene, and bottom layer of higher temperature fibers is selected from the group consisting of meta-aramid, para-aramid, polyphenylene sulfide, polyimide and polytetrafluoroethylene.

16. A composite textile material according to claim 14 employed for the removal of fine particulate matter from a gas stream wherein top layer is a mixture of higher temperature staple fibers selected from the group consisting of meta-aramid, para-aramid, polyphenylene sulfide, polyimide and polytetrafluoroethylene, and bottom layer is a mixture of higher temperature fibers selected from the group consisting of meta-aramid, para-aramid, polyphenylene sulfide, polyimide and polytetrafluoroethylene.

17. A composite textile material according to claim 14 employed for weld splatter protection wherein preoxidized polyacrylonitrile staple fibers comprise both top and bottom layers.
